(19) United States
(12) Patent Application Publication
(10) Pub. No.: US 2023/0256912 A1
(43) Pub. Date: Aug. 17, 2023

(54) MESSAGING PRODUCT HOLDER WITH ATTACHMENT MEANS FOR USE INSIDE A PASSENGER VEHICLE, AND PREFERABLY ON A SUN VISOR INSIDE THE VEHICLE

(71) Applicant: Marc Chase Weinstein, Glen Cove, NY (US)

(72) Inventor: Marc Chase Weinstein, Glen Cove, NY (US)

(21) Appl. No.: 18/109,597

(22) Filed: Feb. 14, 2023

Related U.S. Application Data
(60) Provisional application No. 63/310,698, filed on Feb. 16, 2022.

(51) Int. Cl. B60R 7/05; B60R 7/08

(52) U.S. Cl. CPC B60R 7/05; B60R 7/084; B60R 2011/0059

(57) ABSTRACT

A method and an apparatus for a messaging product holder to be used inside a passenger vehicle, configured to include therein/thereon multiple messaging areas, so that no matter which location in the vehicle an occupant has attached the holder or whatever one of a plurality of orientations that the location may have, one or more of the messaging areas is always visible or exposed to an occupant of the vehicle.

### CROSS-REFERENCE TO RELATED APPLICATIONS

This application claims the benefit of U.S. Provisional Application No. 63/310,698, filed on Feb. 16, 2022, the contents of which are incorporated herein by reference in its entirety.

### BACKGROUND

### Field

The present invention relates generally to a method and an apparatus for a new product holder, configured to include therein/thereon multiple messaging areas, so that no matter which location in a passenger vehicle a user has attached the holder or whatever one of a plurality of orientations that the location may have, one or more of the messaging areas is always visible or exposed to an occupant of the passenger vehicle.

### Description of Related Art

Various products are stored inside almost every car and truck. The range of products is very broad, such as hand lotion, first aid kits, flashlights, tissue boxes, air fresheners and now more recently a range of PPE (Personal Protection Equipment) products. Hand sanitizers, masks, gloves, etc. are now frequent staples in our passenger vehicles.

Personal Sanitizers (hand and other styles) have been available for many years. As a result of the recent pandemic, sanitizer usage has grown and post-Covid it will continue to be a major personal product category.

Currently, it is not easy or convenient to store personal sanitizers and other products in a passenger vehicle where they are easily accessed by an occupant since we often have many items stored in a location that is most convenient to the occupants, such as the glove box, console, door pockets, rear view mirror, etc.

The options are the glove compartment, armrest compartment, open console tray, side pocket on passenger vehicle doors, a pocket behind a front seat, etc. A passenger vehicle’s sun visor is an excellent place to hold items for quick access. Although it is known that products have been made for many years that attach to the visor, these products have not included a full range of valuable messaging areas that would benefit a company for advertising, or delivering various information or providing the user with something of interest and, therefore, value to them. i.e:, images of nature, pets, etc.

It would be desirable that a product holder be configured to include therein/thereon multiple messaging areas, so that no matter which location in the passenger vehicle the user has attached the holder or what orientation that location may currently be if that location is able to be reoriented by the user, one or more of the messaging areas is always visible or exposed to an occupant of the vehicle. However, no such product holder for attachment inside a passenger vehicle, and more specifically upon a sun visor that is able to be reoriented by the user, currently exists.

### SUMMARY

All embodiments of the present invention comprise a messaging product holder including means for causing attachment of the product holder by a user or occupant of a passenger vehicle to an attachment location in the passenger vehicle, such as the sun visor of the vehicle. The product holder has at least two, and preferable up to four or more distinct messaging areas. The multiple messaging areas are included in or on the product holder so that at least one, and preferable two or more, are visible to the user or occupants of the vehicle while in the vehicle, irrespective of the position of the sun visor, which sun visor is adjustable to a range of positions.

That is, irrespective of reorientation of the location at which the product holder is attached, such as a sun visor having multiple possible orientations during use, at least one of the messaging areas remains visible to the user or occupant. The product holder may include up to four or more distinct messaging areas positioned therein or thereon to maximize the likelihood that at least one, and preferably two or even more of the messaging areas are simultaneously visible to a user or occupant in the passenger vehicle. These messaging areas provide a place for textural and/or graphic communication to the user or occupant, such as advertisement messaging that is directed to the driver or passenger, depending upon the location in the passenger vehicle the user has secured the holder.

The present invention, referred to herein as the “EASY REACH”™ car messaging product holder, provides a first of its kind messaging solution to occupants of a passenger vehicle.

With an EASY REACH™ passenger vehicle messaging product holder, companies that use promotional products will always have their logo and/or other messaging in sight of the user or occupant of the vehicle, that is, in one example, irrespective of repositioning of a sun visor within the vehicle. In addition to promotional advertising, the messaging can also be for instructions or warnings ie: “Don’t drink and drive!” or to just provide imaging that is pleasing or valued by the user such as images of nature, uplifting quotes, etc.

In one preferred embodiment of the invention the at least one messaging area visible to an occupant of the passenger vehicle changes from a first one of the messaging areas to a second one of the messaging areas when the orientation of the attachment location is repositioned from a first orientation to a second orientation.

As will be described in the below examples, such as in FIGS. 6, 7A, 7B and 8 which illustrate one example of this preferred embodiment, the messaging product holder of the invention includes a clip for attaching the holder to the sun visor of a passenger vehicle. The clip attaches a side of the product holder substantially parallel to flat surface of the sun visor. In these embodiments, the messaging product holder has a separate attachable sanitizer that that can be removed from the messaging product holder to be used in the vehicle or carried with the user. In other versions, it is anticipated that some of the various products that can be used with the inventive messaging product holder will be formed integral with the holder and the entire unit would be removable from the visor or other locations for use inside or outside the passenger vehicle.

It is noted that a message within the messaging area can be created using an “imprint” into the material forming the messaging product holder 10, or by providing the message on a label that is adhered to the messaging area. In either case, the messaging area provides a place for communication messaging whether it be branding, information or just an attractive visual or written image. This can be accomplished using well known flat printing techniques, other novel visual technologies like lenticular or 3D printing or a 3-dimensional element with graphic relief that is used on the smaller exposed side or other areas such as the clip where a logo could be embossed into the tool as one embodiment. Furthermore, the image can be designed into the moulded surface area on the manufacturing tool, printed directly onto the surface material of the messaging areas, provided by a label or other attachable element (metal, wood, glass, etc.) that has been made with a message whether 2-dimensional or 3-dimensional, that attaches or adheres to the messaging areas described.

### BRIEF DESCRIPTION OF DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings and disclosure depict exemplary embodiments of the invention and are therefore not to be considered limiting of the scope of the particular forms described, for those skilled in the art will recognize additional embodiments of the present invention, which covers all modifications, equivalents, and alternatives within the spirit and scope of the present invention as defined by the appended claims.

FIGS. 1, 2, 3, 4 and 5 illustrate an embodiment of the messaging product holder configured for releasable holding a product, such as a sanitizer dispenser, therewith, according to embodiments of the invention.

FIGS. 6, 7A, 7B and 8 illustrate an embodiment of the messaging product holder affixed to a sun visor of a passenger vehicle, according to embodiments of the invention.

FIGS. 9 and 10 illustrate a flashlight embodiment of the messaging product holder, according to embodiments of the invention.

FIGS. 11, 12 and 13 illustrate a compact first aid kit embodiment of the messaging product holder, according to embodiments of the invention.

FIGS. 14, 15 and 16 illustrate an embodiment of the messaging product holder having an elastic member for securing a product therewith, according to embodiments of the invention.

FIGS. 17 and 18 illustrate an embodiment including a clamp to secure a product to the holder, according to embodiments of the invention.

FIGS. 19 and 20 illustrates an embodiment of the invention where in place of friction fit tabs being used to replaceably attach a product to the holder, the holder has a lid and hinge arrangement for securing a product in a recess of the holder, according to embodiments of the invention.

### DETAILED DESCRIPTION

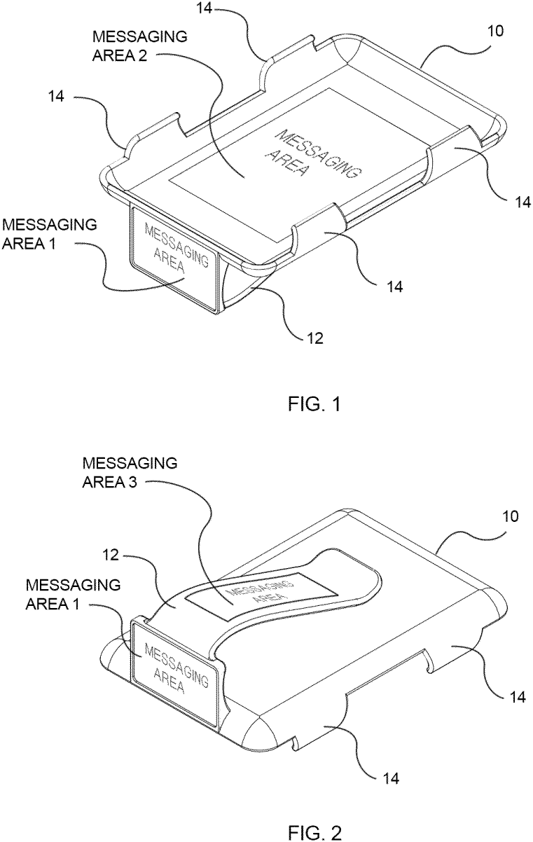

FIGS. 1, 2 and 3 illustrate an embodiment of the messaging product holder 10 configured for releasable holding a product 11, such as a sanitizer dispenser, therewith. Messaging product holder 10 includes a molded clip 12 of allows conventional design which is useful for attaching the holder 10 to a location inside the vehicle, such as the sun visor shown in FIGS. 6-8. Friction fit tabs 14 are shown as one example of releasable product holding means included with holder 10. Alternative releasable product holding means are shown in FIGS. 11-20.

In these first described embodiments, the sanitizer product 11 “snaps in and out” of the messaging product holder 10 while it is mounted on the sun visor of a passenger vehicle, or other area inside the vehicle, via integrated friction fit tabs 14. This always positions the messaging product holder 10 in the perfect place, just above the driver and passenger’s head on the sun visor within fingertip reach, as well as other locations. However, in addition to a great location for “easy reach use” upon entering the vehicle, it also allows a simple “snap in and snap out” usage holder that saves time and is both easy and convenient to remove and replace.

In accordance with an aspect of the invention shown in FIGS. 1-3, messaging areas 1, 2 and 3 are included on the holder 10, with messaging areas 2 and 3 being on opposed first and second sides of the body of holder 10 and messaging area 1 being on a side of the holder that is substantially perpendicular to the first and second sides. If the clip 12 is said to be on the back/rear side of holder 10, then messaging area 3 is the backside of holder 10, messaging area 2 is on the front side of holder 10, and messaging area 1 is on a side of holder 10 that is substantially perpendicular to messaging area 2.

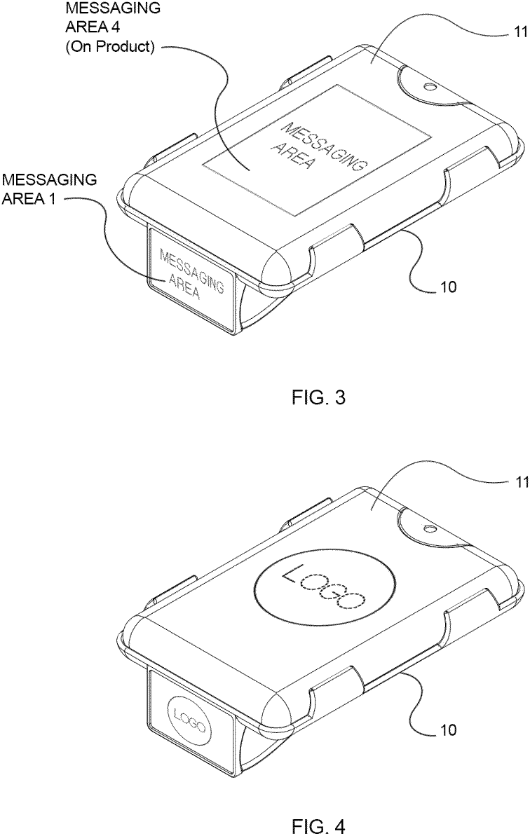

Note that FIG. 3 is similar to FIG. 1, but because a product 11 is attached, in this embodiment product 11 is a disposable sanitizer dispenser, messaging area 2 is obscured by the sanitizer product 11, however an outward facing portion of sanitizer product 11 can be used for providing a messaging area 4 to the user or occupant. Note messaging area 1 is unchanged, and depending on the position of the user or occupant, including their height, and the position of the holder 10, the user or occupant may be able to simultaneously see either both of messaging areas 1 and 4 or 1 and 3, and if the product 11 is not secured within holder 10, then simultaneously see messaging areas 1 and 2.

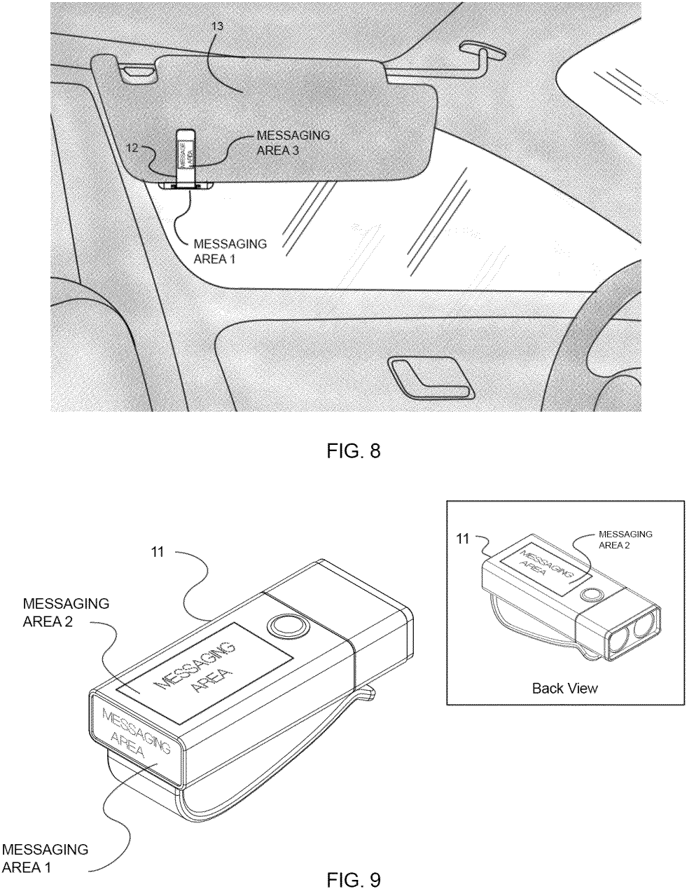

Another benefit provided by this embodiment that uses the snap-in style holder with a sanitizer, is that the sanitizer product 11 can be positioned in the holder upright or inverted. This allows the orientation of the image area on the product 11 to be even more understandable to the user or occupant. The clip 12 can now be attached from the bottom of the unit to a visor or inverted (as shown by these Figures) so that the clip is positioned to hang and clip on the top of a back seat pocket (the opposite of the sun visor orientation shown in FIG. 8). Additionally, positioning still provides for messaging on what is now the top of the holder as well as the front face of the sanitizer product 11, which surfaces are directed 90 degrees differently than the top edge. This clip could also be used on a pocket of a bag, belt, etc., in this inverted position, adding to its advantages.

When using a “clip” mechanism on the holder it also allows the user or occupant to clip it to their belt or other articles that are worn: coat, shirt collar or pocket, etc. While this can be a benefit for all products it has special value if the EASY REACH™ product is a flashlight, as will be described in conjunction with FIG. 9. If a user or occupant has car problems, they can use this flashlight for safety if they have to leave their car or stand near it to alert other motorists of their presence.

FIG. 4 is similar to FIG. 3, however the product is illustrated as a slim sanitizer dispenser, and messaging areas 1 and 4 is used to display a logo.

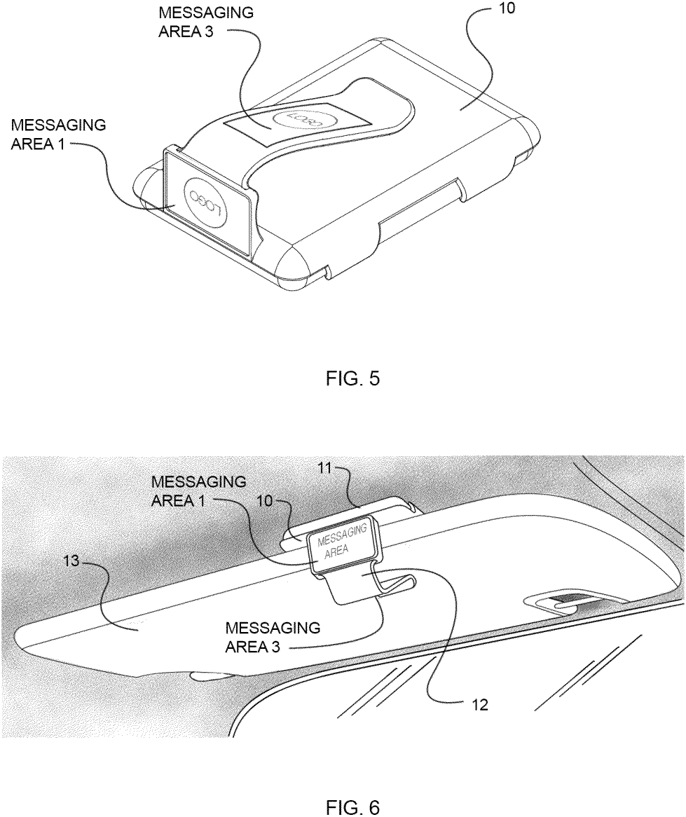

FIG. 5 is a different perspective view of FIG. 4, however clip 12 is not used to provide a messaging area 3

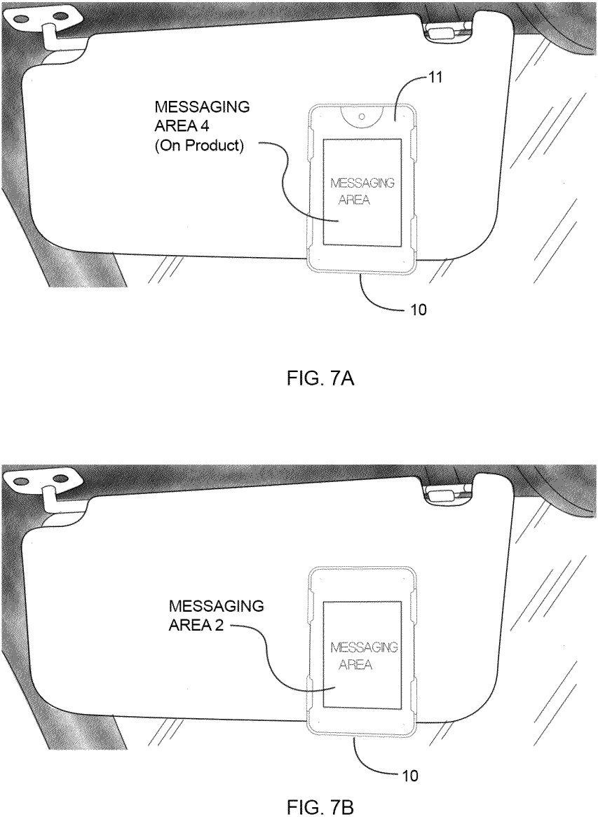

FIG. 6 illustrates use of the messaging product holder 10 by attachment, using clip 12, to a sun visor 13 inside a vehicle. Note that the clip 12 is used to slide the product holder 10 over an edge of sun visor 13 to securely attach the back side of product holder 10 substantially parallel with the major/flat surface of the sun visor 13. Similar to what is shown in FIG. 3, holder 10 with product 11 is shown with an attachment location, the sun visor 13, having an “up” orientation. In this position and orientation, messaging area 1 is substantially perpendicular with the major flat surface of the sun visor 13 and faces the interior of the passenger vehicle so that the messaging area 1 is clearly exposed/visible to the user or occupant, and possibly messaging area 3, which is on clip 12. Of course, if holder 10 is attached to the sun visor 13 so that the clip is facing the roof, the opposite orientation shown in FIGS. ’s6-7, then messaging areas 1 and 2 or 4 would be exposed/visible to the user or occupant. FIG. 7A illustrates the arrangement illustrated in FIG. 6, however the visor 13 is reoriented to a downward facing position. In this orientation the sanitizer body is positioned to face the user or occupant, and therefore messaging area 4 on the sanitizer product 11, often used for logos and other advertising images, would be visible to the user or occupant. In the event sanitizer 11 were not secured to holder 10, then messaging area 2 would be visible to the user or occupant.

FIG. 7B illustrates the arrangement illustrated in FIG. 7A, however a sanitizer 11 is not secured to holder 10 and the visor 13 is reoriented to a downward position. In this orientation messaging area 2 would be visible to the user or occupant.

FIG. 8 illustrates the arrangement illustrated in FIG. 7A, but where the visor 13 is reoriented to be in the down position and turned 90 degrees to the driver’s side window to block sun glare. In this position of the sun visor 13, messaging areas 1 and 3 would be simultaneously visible to the user or occupant.

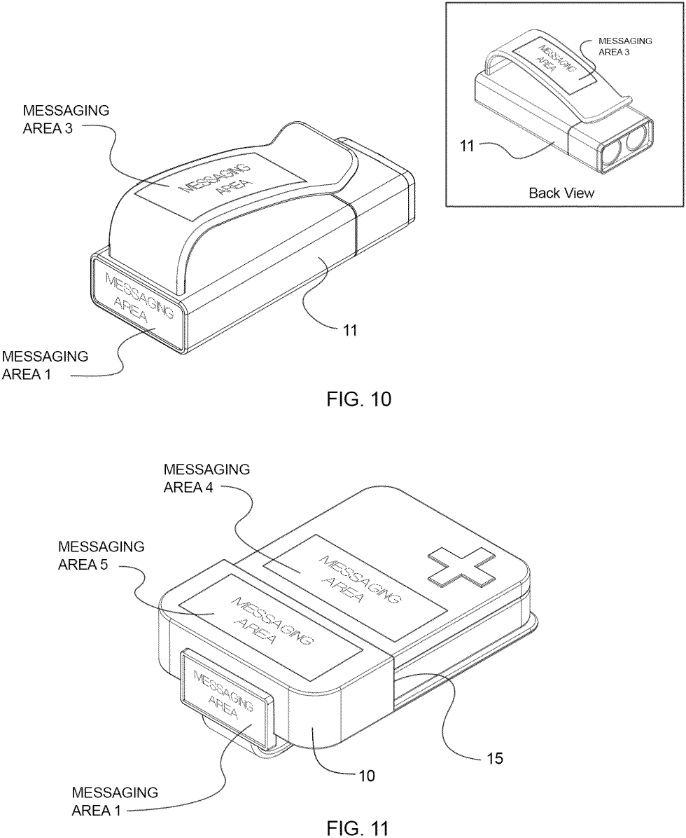

FIGS. 9 and 10 illustrate an embodiment where the product 11 is integrated into the holder, as compared with being releasably attached thereto. In this embodiment, the product is illustrated as a flashlight, but of course other products could be permanently integrated, such as a first aid kit shown below in FIG. 11, which is shown not permanently integrated, in FIG. 11. In the FIGS. 9 and 10 embodiments, since the product is integrated with the holder, message 2 is now formed on a top-facing portion of the messaging product holder 10. Depending on how the flashlight embodiment is attached to the sun visor, such as with the clip 12 facing the roof of the car when the visor is in its standard position, messaging area 1 would be directly facing the user or occupant and messaging area 2 would also be visible to the user or occupant. If the holder were mounted on the visor with messaging area 2 facing the roof of the car, then messaging area 1 and 3 would most likely be visible to the user or occupant.

FIG. 10 illustrates a version of FIG. 9 where the holder is mounted on the visor with messaging area 3 facing the roof of the car. In this embodiment messaging area 1 and 2 would most likely be simultaneous visible to the occupant of the vehicle. Note that when mounted on the sun visor using clip 12, messaging area 1 faces the occupant, and the flashlight points away from the occupant so that in case of an inadvertent activation of the flashlight the light is not directed into the eyes of the occupants. It is noted that this embodiment provides the user or occupant the opportunity to take the holder 10 with them out of the vehicle so that the flashlight could be handheld or attached to a bag, belt, pocket, etc. and provide a hands-free “flashlight” that would move with their body positioning. The flashlight could also have a flashing warning light as an auto safety feature in case the user needed to be outside their vehicle on a road at night. It is noted that the flashlight could be not only be integrated into the holder 10 by itself, but can be incorporated into the holder as shown in FIGS. 1-5 that is adapted to also received a replaceable product 11.

FIGS. 11 - 13 illustrates an embodiment where the replaceable product 11 comprises a compact first aid kit. In this embodiment in place of friction fit tabs 14, a pocket 15 is provided in which the first aid kit can slide therein, thereby releasable secure the first aid kit to the holder 10. Although when the first aid kit is secured on holder 10 the first aid kit will obscure messaging area 2 from view by the user or occupant, a messaging area 5 is provided on the pocket for presentation to the user or occupant. When the first aid kit is not being secured on holder 10, messaging area 2 would also be become visible to the user or occupant. Irrespective of holder 10 having secured thereto a first aid kit, messaging area 1 remains visible to the user or occupant. Additionally, messaging area 5, or any messaging area in the embodiments shown herein, can comprise or include a scent mechanism, such as a well-known scent strip, with graphic or other printing so as convey a message while also providing a scent, such as an air freshener.

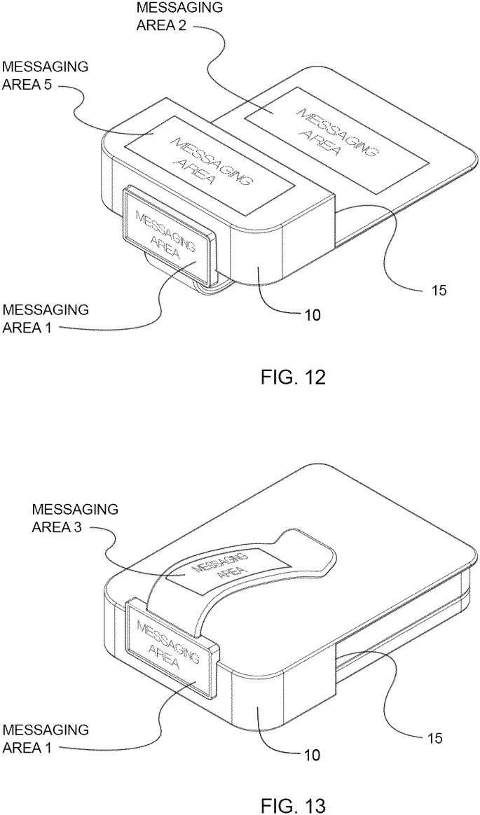

FIG. 12 is similar to FIG. 11, however the first aid kit is shown removed, thereby exposing messaging area 2 above pocket 15.

FIG. 13 illustrates a rear view of the holder 10 of FIGS. 11 and 12, showing that messaging areas 1 and 3 may be visible to the user or occupant.

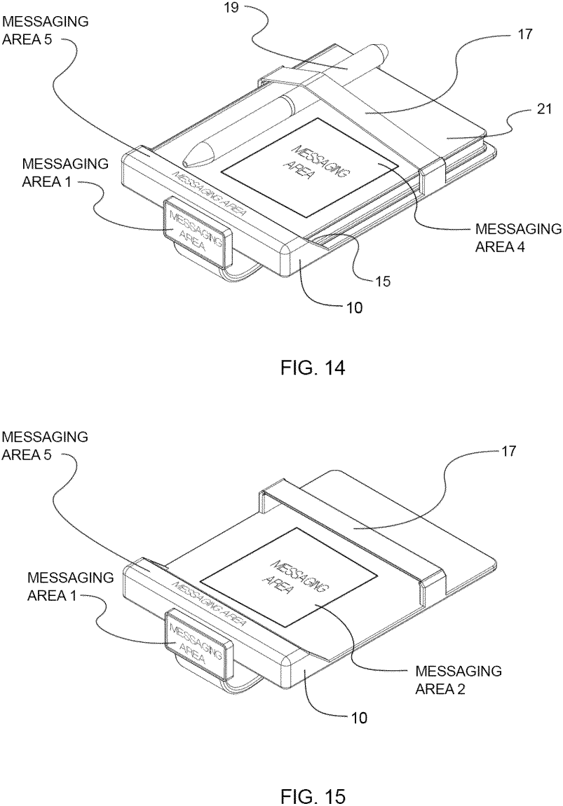

FIG. 14 illustrates a further embodiment of the invention of the type having a pocket 15 like that shown in FIG. 13 but shorter, and an elastic member 17, such as an elastic band, which in this embodiment holds a pen 19 and pad 21 in place. In this embodiment, messaging areas 1, 4 and 5 are displayed to the user or occupant. It is noted that items other than a pen and pad could be held in pocket 15 by the elastic member 17.

FIG. 15 illustrates FIG. 14 with pen and pad removed, thereby additionally exposing messaging area 2 to the user or occupant.

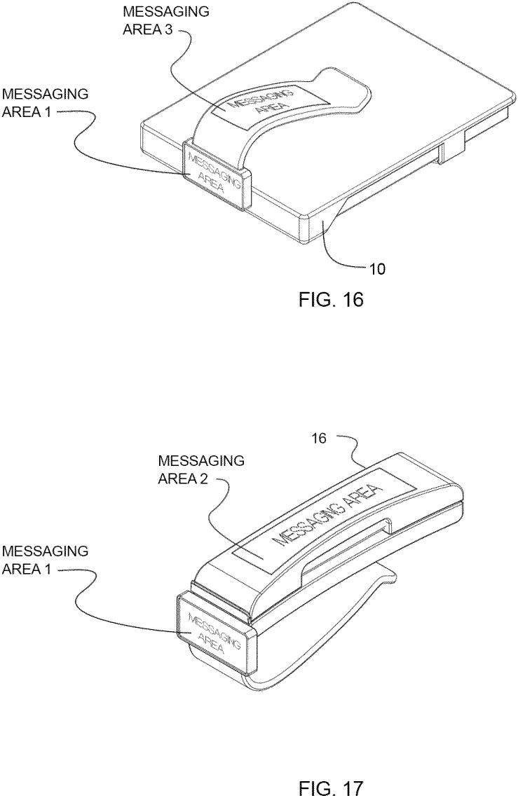

FIG. 16 illustrates the opposite side of the embodiment shown in FIGS. 14 and 15, so as to illustrate how messaging areas 1 and 3 may be visible to the user or occupant.

FIG. 17 illustrates an embodiment where in place of friction fit tabs 14 being used to replaceable attach a product, a clamp 16 is used to secure, for example a pair of sunglasses to the messaging product holder 10. As shown herein, messaging area 2 can be formed on the clamp 16, so that messaging areas 1 and 2 may be simultaneously visible to the user or occupant.

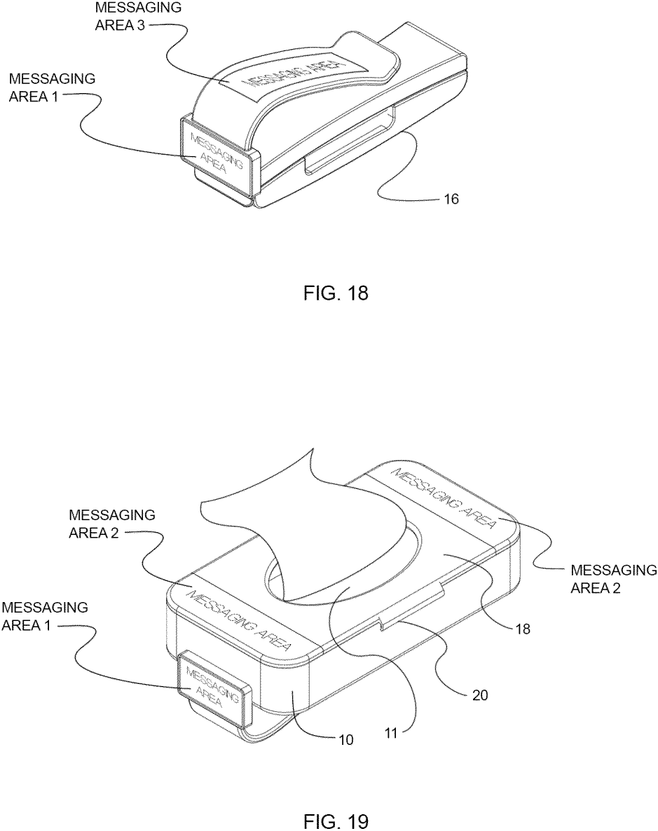

FIG. 18 illustrates the opposite side of the embodiment shown in FIG. 17, thereby showing messaging areas 1 and 3 being presented to the user or occupant.

FIG. 19 illustrates an embodiment of the invention where in place of friction fit tabs 14 being used to replaceably attach a product 11, the holder 10 has a lid 18 and hinge 20 for securing the product 11 in a recess of the holder 10. In this embodiment, the product 11 comprises a box of tissues. In this embodiment messaging areas 1 and 2 are presented to the user or occupant, where messaging area 2 is split into two locations on the front face of messaging product holder 10

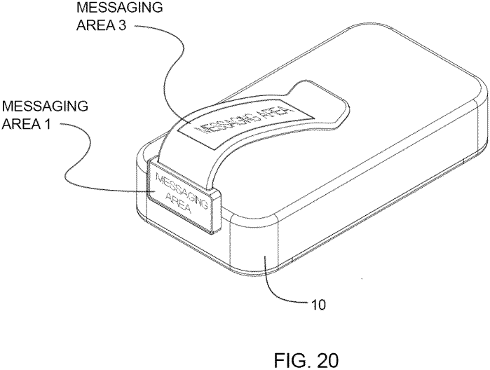

FIG. 20 illustrates a rear view of FIG. 19, where messaging areas 1 and 3 are exposed to the user or occupant.

It is anticipated that in some versions of the above-described embodiments there may be a scent strip attached to the holder. For user or occupants who enjoy scented environments the unique positioning of Easy Reach™ messaging product holder provides an excellent location of close proximity to the nose while in the vehicle so as to enjoy a fragrance more directly.

In accordance with a further alternative to the above-described embodiment, a mirror may be included on the inside back of the holder 10 (that is, in place of messaging area 2 in the above-described embodiments). This allows the user or occupant a direct view of their face when the sanitizer is removed without having to “open” the car’s visor mirror which are almost exclusively made with covers in current vehicles. This eliminates an additional step for the user or occupant. If the user or occupant takes the Easy Reach™ clip holder and sanitizer with them away from the car they will also have access to a mirror with them.

In accordance with a further alternative to the above described embodiment, the addition of a small hook can be incorporated into messaging product holder 10 so as to allow the user or occupant to hang a face mask so that it is in “easy reach” and has less likelihood of becoming contaminated from various germs. Often mask wearers will just lay their mask on a seat or put it into a storage area with money and other common items that are notorious for carrying germs, thus contaminating their mask.

Although only a few exemplary embodiments of the present invention have been described in detail above, those skilled in the art will readily appreciate that many modifications are possible in the exemplary embodiments without materially departing from the novel teachings and advantages of this invention. For example, all of the above-described embodiments can be constructed in any one of a variety of ways and with various materials. For example, in the embodiments shown in at least FIGS. 1-8, the product holder and clip are formed as one-piece via a plastic mold. Alternatively, other variations are possible, including making the clip a separate part, such as from a metal substrate that would attach to the holder. The clip may be just an angled one-piece pressure clip or a spring mechanism to further increase the “grip” pressure, or other types of known attachments that would effectively secure the holder and product (e.g., a sanitizer) to a sun visor, pocket, etc. These and further embodiments of the invention may be devised without departing from the basic scope thereof.

1. A messaging product holder for use by an occupant of a passenger vehicle, comprising:
a body having means for releasably securing a product to a first side of the body;
a clip included with a second side of the body that is opposite to the first side for enabling attachment of the second side of the body substantially parallel to a surface having an attachment location in the passenger vehicle;
a plurality of messaging areas located on the messaging product holder, including first and second messaging areas located on the first and second sides of the body, respectively, as well as a third messaging area located on a side of the clip that is substantially perpendicular from the first side of the body. wherein;
the surface having the attachment location is positionable by the occupant from a first orientation within the vehicle to a second orientation within the vehicle, such that if the surface is changed from the first orientation to the second orientation, the messaging area visible to the occupant changes from a first of said messaging areas to a second of said messaging areas.

2. The messaging product holder of claim 1, wherein
when said surface is in the first orientation at least two messaging areas are visible to the occupant of the vehicle, and when said surface is in the second orientation at least one of the at least two messaging areas is visible to the occupant of the vehicle, as well a third messaging area.

3. The messaging product holder of claim 2, wherein
said means for releasably securing a product to said first side of the body includes the first messaging area positioned therebetween; and
when a product is secured to said first side of the body by said means for releasably securing, a further messaging area on said product will overlie the first messaging area and be visible to the occupant of the vehicle.

4. The messaging product holder of claim 2, wherein said surface comprises a major flat surface of a sun visor of the vehicle.

5. A messaging product holder for attachment to a sun visor of a passenger vehicle, comprising:
a body having means for releasably securing a product to a first side of the body;
a clip included with a second side of the body that is opposite to the first side for enabling attachment of the second side of the body to the sun visor in the passenger vehicle, and
a plurality of messaging areas located on the messaging product holder, wherein:
said sun visor has multiple possible orientations during use, and
irrespective of reorientation of the sun visor, at least one of the messaging areas remains visible to the user or occupant.

6. The messaging product holder of claim 5, wherein:
said messaging product holder has first and second messaging areas located on the first and second sides of the body, respectively, as well as a third messaging area located on a side of the clip that is substantially perpendicular to the first side of the body; and wherein
when the sun visor position is changed from a first orientation within the vehicle to a second orientation within the vehicle that is substantially perpendicular to the first orientation, the messaging area visible to the occupant changes from one or more of said first, second or third of said messaging areas to a different one or more of said first, second or third of said messaging areas.

7. The messaging product holder of claim 5, wherein
when said messaging product holder has first and second messaging areas located on the first and second sides of the body, respectively;
said means for releasably securing a product to said first side of the body includes the first messaging area positioned therebetween; and wherein
when a product is secured to said first side of the body by said means for releasably securing, a further messaging area on said product will overlie the first messaging area and be visible to the occupant of the vehicle.

8. A messaging product holder for attachment to a sun visor of a passenger vehicle, comprising:
a body having a product on a first side of the body;
a clip included with a second side of the body that is opposite to the first side for enabling attachment of the second side of the body to the sun visor in the passenger vehicle, and
a plurality of messaging areas located on the messaging product holder, wherein:
said sun visor having multiple possible orientations during use, and
irrespective of reorientation of the sun visor, at least one of the messaging areas remains visible to an occupant of said vehicle.
